(19) United States
(12) Patent Application Publication
(10) Pub. No.: US 2015/0112961 A1
(43) Pub. Date: Apr. 23, 2015

(54) User Submission of Search Related Structured Data

(71) Applicant: Google Inc., (US)

(72) Inventors: Rui Jiang, Bellevue, WA (US); Hui Xu, Palo Alto, CA (US)

(73) Assignee: Google Inc., Mountain View, CA (US)

(21) Appl. No.: 13/622,232

(22) Filed: Sep. 18, 2012

(51) Int. Cl. G06F 17/30; H04L 29/06

(52) U.S. Cl. CPC G06F 17/30867; H04L 63/10
USPC 707/709; 707/E17.108

(57) ABSTRACT

Methods and apparatus related to obtaining search related structured data from a user. A user submitted update instruction may identify at least one URL and provide access to associated user supplied search related structured data. An associated record in a database may be modified by including the user supplied search related structured data in the record. The record is related to the URL and the database may be a structured data database associated with a search engine.

### BACKGROUND

This specification is directed generally to associating search related structured data with a searchable document such as a webpage. Search related structured data is data pertaining to at least one searchable document that is logically organized into a set of objects with a set of attributes. Structured data may enable more robust searching of webpages and/or a more robust display of search results associated with webpages.

Search related structured data may be presented in one or more of a variety of formats. For example, PageMap explicitly represents structured data as data objects with attributes and values. PageMap may be encoded as an XML block embedded in a webpage and may be associated with a webpage in a database via scheduled crawling and indexing of that webpage. Also, for example, search related structured data may additionally or alternatively be represented in other formats such as meta tags, Microformats, RDFa, and/or Microdata.

### SUMMARY

The present disclosure is directed to methods and apparatus for user submission of search related structured data. For example, some implementations are directed to methods and apparatus for associating user supplied search related structured data with a URL record in a database in response to direct user submission of the search related structured data. Also, for example, some implementations are directed to methods and apparatus for including user supplied search related structured data in a record in a database in response to an update instruction from a user.

In some implementations a computer implemented method is described that includes the steps of: receiving a user generated request to associate user supplied search related structured data with a URL; receiving the search related structured data for the URL from the user; and associating, in response to the user generated request, the search related structured data with a URL record of the URL for use in response to a search request pertaining to the URL; wherein at least some of the associated search related structured data supplements web crawl data associated with the URL record, the web crawl data obtained through crawling of the URL.

This method and other implementations of technology disclosed herein may each optionally include one or more of the following features.

The search related structured data may include at least one unique attribute type that is distinct from attribute types of the web crawl data obtained through crawling of the URL. In some implementations the unique attribute type may include total number of reviews and/or total number of downloads.

At least some of the search related structured data may supplant certain web crawl search related structured data of the web crawl data obtained through crawling of the URL.

At least some of the search related structured data may be inaccessible through the crawling of the URL.

The method may further include associating at least some of the search related structured data with an access key and requiring a matching access key for access to the associated search related structured data.

The step of associating the search related structured data with the URL record of the URL may occur within a predefined time period of receiving the user generated request.

The method may further include identifying a user submitted indexing quota for the URL and the step of associating the search related structured data with the URL record of the URL may only occur if the user submitted indexing quota has not been exceeded.

In some implementations a computer implemented method is described that includes the steps of: receiving an update instruction from a user, the update instruction identifying at least one URL and providing access to associated user supplied search related structured data; and modifying an associated record in a database by including the user supplied search related structured data in the record. The record is related to the URL and the database is a structured data database associated with a search engine. The update instruction received from the user initiates the modification of the associated record during a previously unscheduled update sequence.

This method and other implementations of technology disclosed herein may each optionally include one or more of the following features.

The search related structured data may include at least one unique attribute type that is distinct from attribute types of web crawl data obtained through scheduled crawling of the URL.

At least some of the search related structured data may supplement certain web crawl search related structured data of web crawl data obtained through crawling of the URL.

At least some of the search related structured data may be inaccessible through crawling of the URL.

The step of modifying the associated record in the database may occur within a predefined time period of receiving the update instruction from the user.

The method may further include identifying a user submitted indexing quota for the URL and the step of modifying the associated record in the database may only occur if the user submitted indexing quota has not been exceeded.

The URL may be a publicly accessible URL appended with a private access key. At least some of the user supplied search related structured data may be accessible via crawling of the URL and inaccessible via crawling of the publicly accessible URL.

At least some of the user supplied search related structured data may be associated with an access key in the database.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein process user supplied search related structured data and associate such data with a URL record in a database for utilization in one or more meaningful search applications. The search related structured data may be utilized by one or more search applications to provide improved performance of the search applications. Particular implementations of the subject matter described herein process user submitted search related structured data for a URL that contains data that is in addition to data obtained via crawling of the URL. The additional data represents new values that are associated with the URL.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a flow chart illustrating an implementation of obtaining search related structured data associated with a URL via submission from a user.

FIG. 2 is a flow chart illustrating another implementation of obtaining search related structured data associated with a URL via submission from a user.

FIG. 3 is a block diagram of an example environment in which search related structured data associated with a URL may be submitted by a user and associated with a record of the URL in a search database.

FIG. 4 illustrates a block diagram of an example computer system.

### DETAILED DESCRIPTION

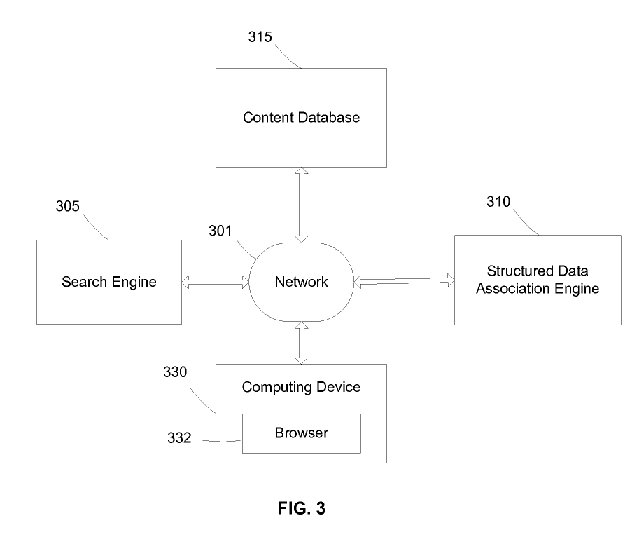

Referring to FIG. 1, a flow chart illustrating an implementation of a method of obtaining search related structured data associated with a URL via submission from a user is provided. Other implementations may perform the steps in a different order, omit certain steps, and/or perform different and/or additional steps than those illustrated in FIG. 1. For convenience, aspects of FIG. 1 will be described with reference to a system of one or more computers that perform the process. The system may be, for example, the structured data association engine 310 of FIG. 3.

At step 100 a request to associate user supplied search related structured data to a URL is received. In some implementations the URL may be directed to a webpage. In some implementations the URL may be directed to another document such as, for example, a PDF document, a DOC document, an image document, and/or a video document. In some implementations the request may be received from a user via computing device 330 (FIG. 3). For example, computing device 330 may transmit an authenticated HTTP POST message to structured data association engine 310 via network 301 that indicates a request to associate user supplied search related structured data with a target webpage. In some implementations the request may be in the form of an on demand indexing request embedded in the HTTP POST message. The HTTP POST message may also include information identifying the target webpage with which the user supplied structured data is to be associated. The structured data association engine 310 may optionally include an application programming interface (API) for receiving and processing the HTTP POST message. In some implementations one or more applications executing on computing device 330 may transmit and/or initiate transmission of the HTTP POST message and/or other message including a request to associate user supplied search related structured data to a target webpage. For example, HTML editors, content management systems, and/or stand-alone applications may be utilized to transmit and/or initiate transmission of a request.

In some implementations the request may be transmitted via a web browser 332 executing on the computing device 330. For example, the web browser 332 may enable access to a webpage via network 301 that includes an interface that enables a user to identify a target webpage and to request that user supplied search related structured data be associated with that target webpage. For example, the target webpage may be identified via a user fillable and/or selectable field and the request may be transmitted from a server hosting the webpage in response to the user actuating a submission button on the webpage. Additional and/or alternative applications may be utilized to request that user supplied search related structured data be associated with a URL.

In some implementations the user must be authenticated as a verified user of the URL in order to submit a request. A verified user of the URL is a user authorized to make changes to the URL. In some implementations the verified user may include the owner of the URL and/or one or more users identified by the owner of the URL as being authorized to make changes to the URL. In some implementations the request to associate user supplied search related structured data to a URL may be accompanied with user authentication data that identifies the user submitting such request as a user authorized to make changes to the URL. For example, in some implementations that utilize a HTTP POST message, the message may include an authorization header that contains an authentication token. Also, for example, in some implementations a username and/or password may be supplied to authenticate the user.

At step 105 the search related structured data is received from the user. In some implementations the search related structured data may be received from computing device 330 via network 301. For example, the computing device 330 may transmit an authenticated HTTP POST message to structured data association engine 310 that includes the search related structured data. In some implementations the structured data association engine 310 may optionally include an application programming interface (API) for receiving the HTTP POST message from one or more applications. In some implementations one or more applications executing on the computing device 330 may transmit and/or initiate transmission of the HTTP POST message and/or other message including the user supplied search related structured data. For example, HTML editors, content management systems, and/or stand-alone applications may be utilized to submit requests.

In some implementations the search related structured data may be transmitted via the web browser 332 executing on the computing device 330. For example, the web browser 332 may enable access to a webpage via network 301 that includes an interface that enables a user to submit search related structured data. For example, the search related structured data may be inserted into a text entry field and/or uploaded via the webpage, then transmitted by the server hosting the webpage. In some implementations the user must be authenticated as a verified user of the URL to upload search related structured data. Additional and/or alternative applications may be utilized by a user to transmit search related structured data.

Provided below is an example of PageMap formatted search related structured data that may be received from a user. PageMap formatted structured data may represent structured data as data objects with attributes and values and may be encoded as an XML block embedded in a webpage in some embodiments. PageMap enables website creators and/or authors to embed data and/or notes in their webpages as well as a variety of other uses for structured data.

```
<Pages>
  <Page url=“http://example.com/zoomabc123.html”/>
  <PageMap>
    <DataObject type=“document”>
    <AccessKey>1234</AccessKey>
    <Attribute name=“title”>zoom abc123</Attribute>
    <Attribute name=“review”>4.0/5.0</Attribute>
    </DataObject>
  </PageMap>
</Page>
<Page url=“http://example.com/example.html”>
  <PageMap url=“http://example.com/example.html” />
  <DataObject type=“document”>
    <Attribute name=“title”>example title</Attribute>
    <Attribute name=“review”>4.8/5.0</Attribute>
  </DataObject>
  </PageMap>
  </Page>
</Pages>
```

The example of PageMap formatted search related structured data includes a “title” attribute and a “review” attribute of a “document” data object for the example webpage “http://example.com/zoomr16.html.” An access key “1234” is also provided for those attributes. As discussed herein, the access key “1234” may be utilized to only enable access to the “title” and “review attributes” when the access key is supplied. The search related structured data also includes a “title” attribute and a “review” attribute of a “document” data object for the example webpage “http://example.com/example.html.” In some implementations search related structured data may additionally and/or alternatively be provided in other formats. For example, search related structured data may additionally or alternatively be provided via user submitted meta tags, Microformats, RDFa, and/or Microdata.

At step 110 the search related structured data is associated with a record of the URL in a search database. In some implementations the search related structured data may be associated with a record of the URL in content database 315 (FIG. 3). For example, the content database 315 may include one or more storage mediums having one or more databases within which each of a plurality of URLs are associated with search related structured data. For example, structured data association engine 310 may store associated URL and search related structured data on content database 315.

For example, for the PageMap formatted search related structured data example provided above, the title attribute “zoom abc123” and review attribute “4.0/5.0” may be associated with the URL “http://example.com/zoomr16.html.” The access key “1234” may also be associated with the document object, title attribute, and/or review attribute for that webpage. In some implementations, the association of the access key “1234” may make the title attribute and review attribute access-restricted data in the content database 315. In order for the access-restricted data to be accessible to a requesting application, that requesting application must provide a matching access key for the access key “1234.” In some implementations an exact match between the access-restricted data access key and the database data access key may be required (e.g., both equal to “1234”). In some implementations the access-restricted data access key and the database data access key may not be an exact match, but still determined to match one another (e.g., via a matching algorithm). For example, the data may only be utilized by a search engine (e.g., search engine 305) when the search engine supplies the access key. For example, the search engine may only utilize the title attribute “zoom abc123” and/or review attribute “4.0/5.0” to identify, order, and/or provide content to search results when the search engine supplies the access key. In some implementations the search engine may be a site-specific custom search engine and the content database 315 may be accessible by the custom search engine. In some implementations the search engine may be a non-site-specific search engine. The access-restricted data may include data that is not available through direct analysis of the URL. For example, the access-restricted data may represent data concerning a publicly accessible webpage that is distinct from any data that may be obtained through crawling of that webpage.

In some implementations the access key may be associated with one or more attributes, but stored in a separate field in the content database 315 than the attributes. In some implementations the access key may be integrated into the access-restricted search related structured data. For example, in some implementations the access key may be appended to an attribute name. For example, the access key may be provided as a prefix with a dash (“-”) to the attribute names “title” and “review,” thereby creating modified attribute names “1234-title” and “1234-review.” Also, for example, the access key may be provided as a suffix to the attribute names “title” and “review,” thereby creating modified attribute names “title1234” and “review1234.” Such attributes may then only be utilized in a search by appropriately appending the necessary access key to the appropriate attribute. For example to use a private review attribute to sort search results, the command “sort=document-review1234” may be submitted with the search.

Also, for example, in some implementations the access key may be appended to the data object. For example, the access key may be provided as a prefix to the data object name “document,” thereby creating modified data object name “1234document.” Also, for example, the access key may be provided with a dash (“-”) as a suffix to the data object “document,” thereby creating modified data object “document-1234.” Such data object may then only be utilized in a search by appropriately implementing the necessary access key to the appropriate object. For example, to use a private review attribute to sort search results, the command “sort=1234document-review” may be submitted with the search.

Additional and/or alternative methods of integrating the access key into the access-restricted search related structured data may be utilized. For example, other methods of appending the access key to an attribute name, such as interspersing the access key throughout an object and/or attribute name (e.g., “d1o2c3u4ment”), may be utilized. Additional and/or alternative methods of otherwise restricting access to search related structured data may be utilized.

Also, for the PageMap formatted search related structured data example provided above, the title attribute “example title” and review attribute “4.8/5.0” may be associated with the webpage “http://example.com/example.html” in a database. In some implementations the review and title attributes may be non-access restricted since they were not provided with an access key. In some of those implementations the review and title attributes may be in a database that is publicly accessible and that enables viewing of the values associated with the attributes. In some of those implementations the review and title attributes may additionally and/or alternatively be publicly accessible via separate presence in code of the URL.

In some other implementations the review and title attributes may be private data that is not directly viewable to the public, but that may be utilized by a search engine (e.g., search engine 305) having access to content database 315, without requiring an access key to be provided. For example, in some implementations one or more search engines may enable identification and/or restriction of search results based in whole or in part on a review attribute, without making that review attribute directly publicly accessible. For example, a search for reviews of greater than 4.0 out of 5.0 may return a URL based on a private review of 4.5 associated with that URL, without necessitating providing the specific value of that private review (e.g., may be referred to as “greater than 4.0”). Also, for example, a search for shopping results based on the number of reviews may return a result based on the number of reviews for that result without necessitating providing public access to the specific number of reviews (e.g., the number may be omitted from the result). Any such publicly accessible, but private data may be maintained in a database for access by a single search engine or by a plurality of search engines. For example, in some implementations the database may include data for a shopping website having private search related structured data for a plurality of shopping items. The database may enable searching, filtering, and/or sorting of such private search related structured data by a plurality of search engines, but not enable the actual data to be viewed.

In some implementations private and/or access-restricted data may include data pertaining to the perceived quality of the originator of the URL with which such data is associated. For example, in an application search engine in which a user may search for and/or download applications for a computing device, it may be desirable to have private and/or access-restricted data that may be utilized to demote and/or restrict URLs for applications that are related to one or more persistently problematic publishers (e.g., publishers that persistently publish applications having unacceptable security or other violations). In some implementations one or more aspects of the user supplied search related structured data may be related to structured data fields that may not be updated frequently and/or may not be otherwise updated. For example, user supplied search related structured data may change the publication date of a URL to reflect republication of the URL and/or for another purpose. Such user supplied search related structured data may change the publication date across all search databases associated with the URL, or only in a subset of one or more databases.

In some implementations a user submission of search related structured data may be associated with the URL in the content database 315 and available for utilization by a search engine within a predefined time of submitting the search related structured data. For example, in some implementations the search related structured data may be associated with the URL in the content database 315 and available for utilization in less than six hours from submission. In some implementations a user submission of search related structured data may be associated with the URL in the content database 315 and available for utilization by a search engine during a previously unscheduled update sequence. For example, in some implementations the URL may not be scheduled in the near future for crawling to obtain any updated search related structured data. However, upon receiving a request and search related structured data from a user, the search related structured data may be associated with the URL in the content database 315 within a certain amount of time from submission (e.g., within 1 hour, 3 hours, 6 hours, 24 hours).

In some implementations a search related structured data submission quota may be provided for each URL and/or user. For example, in some implementations only a predetermined amount of search related structured data submissions may be submitted for each URL over a given time period. In some implementations if the quota is exceeded no more search related structured data submissions will be accepted. In some implementations, if the quota is exceeded, the update time for associating the URL with the search related structured data in the content database 315 may be affected. For example, the first four submissions for a URL for a month may be guaranteed for update within 6 hours, the next four submissions guaranteed for update within 24 hours, and the next four submissions guaranteed for update within a week. In some implementations quotas may be applicable to a domain, a URL, a user, a set of domains, and/or a set of URLs. The quotas may optionally be individually configured per entity (e.g., some domains and/or URLs provided with a higher quota than others).

At step 115 at least some of the search related structured data supplements web crawl data obtained via crawling of the URL. In some implementations the search related structured data may supplement other structured data obtained through crawling the URL that is optionally also stored in content database 315. For example, in some implementations the user submitted search related structured data may include private, optionally access-restricted, data that is inaccessible via crawling of the URL. Such private search related structured data may be stored in content database 315 and represent data that is in addition to any structured data obtained through crawling of the URL. Also, for example, in some implementations user submitted search related structured data may include data that is accessible via crawling of the URL, but the URL has yet to be crawled since the data was present on the URL. Accordingly, such data may supplement other structured data that had been obtained through crawling of the URL. If the data relates to an attribute that had not previously been defined through crawling of the URL, then in some implementations the data may supplement and be in addition to data obtained via crawling of the URL. If the data relates to an attribute that has previously been defined through crawling of the URL, then in some implementations the data may supplement and optionally supplant data obtained via crawling of the URL.

In some implementations any user submitted search related structured data will be merged with any existing search related structured data obtained via crawling of the URL. For example, a single set of search related structured data may be associated with a URL with the user submitted search related structured data being in addition to and/or supplanting any existing search related structured data obtained via crawling of the URL. In some of those implementations only that single set of search related data may be accessed by an application such as a search application. In some implementations user submitted search related structured data may only be accessible via a search performed by a custom search engine.

In some implementations that implement access-restriction, a separate set of access-restricted search related structured data may be provided that includes user submitted search related structured data. In some implementations only user submitted search related structured data is included in such a separate set. In some implementations search related structured data obtained via crawling of the URL may also be included in such a separate set. For example, in some implementations that implement an access key, a separate set of search related structured data will be provided that includes user submitted search related structured data and search related structured data obtained via crawling of the URL. The access-key may optionally be appended to all search related structured data (including data obtained via both user submission and crawling of the URL).

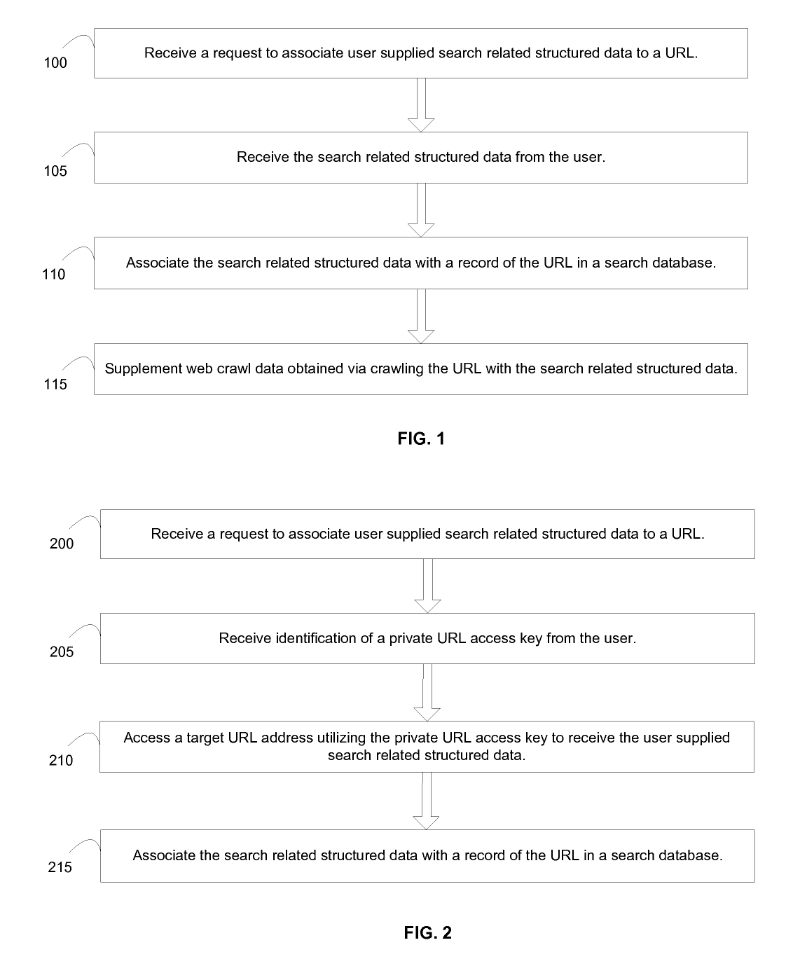

Referring to FIG. 2, a flow chart illustrating another implementation of a method of obtaining search related structured data associated with a URL via submission from a user is provided. Other implementations may perform the steps in a different order, omit certain steps, and/or perform different and/or additional steps than those illustrated in FIG. 2. For convenience, aspects of FIG. 2 will be described with reference to a system of one or more computers that perform the process. The system may be, for example, the structured data association engine 310 of FIG. 3.

At step 200 a request to associate user supplied search related structured data to a target URL is received. In some implementations step 200 and step 100 of FIG. 1 may share one or more common aspects. In some implementations the URL may be directed to a webpage or another document such as, for example, a PDF document, a DOC document, an image document, and/or a video document. In some implementations the request may be received from a user via the computing device 330. For example, computing device 330 may transmit an authenticated HTTP POST message to structured data association engine 310 via network 301 that indicates a request to associate user supplied search related structured data with a target URL. The HTTP POST message may also include information identifying the URL with which the user supplied structured data is to be associated

In some implementations the request may be initiated and/or transmitted via a web browser 332 executing on the computing device 330. In some implementations HTML editors, content management systems, and/or stand-alone applications may be utilized to initiate and/or transmit requests. Additional and/or alternative applications may be utilized to request that user supplied search related structured data be associated with a URL.

In some implementations the user must be authenticated as a verified user of the target URL to submit a request. In some implementations the request to associate user supplied search related structured data to a target URL may be accompanied with user authentication data that identifies the user submitting such request as a user authenticated to make changes to the URL.

At step 205 identification of a private URL access key is received from the user. The private URL access key is a key that may be utilized when accessing a target URL that causes the target URL to return search related structured data. For example, a target URL accessed without the access key may return XML and/or HTML data that does not include certain (or any) search related structured data. However, accessing the target URL utilizing the access key will cause the certain search related structured data to be include in the XML and/or HTML data. For example, accessing a target URL “http://www.example.com/product1/” will not return certain search related structured data. However, given an access key of “Sd34Dlkdh”, that search related structured data may be accessed by accessing “http://www.example.com/product1/?StructuredDataAccessKey=Sd34Dlkdh”.

At step 210 the target URL address is accessed utilizing the private URL access key to receive the user supplied search related structured data. In some implementations the target URL address may be accessed to extract user supplied search related structured data by data association engine 310 via network 301. For example, the data association engine 310 may access the target URL address with the access key appended thereto to obtain access to the search related structured data only accessible with the access key. In some implementations the search related structured data may be returned in the code of the URL. For example, when a webpage is accessed by the URL address with the access key appended thereto the search related structured data may be returned in the XML and/or HTML code of the webpage and extracted therefrom by data association engine 310.

For example, for a target URL “http://www.example.com/product1/” with an access key of “Sd34Dlkdh,” certain search related structured data may be accessed by accessing “http://www.example.com/product1/?StructuredDataAccessKey=Sd34Dlkdh.” A user having ownership of the target URL may determine which search related structured data is returned when the target URL is accessed with the access key. In some implementations the accessed search related structured data may only include data which the user wishes to remain private and/or access-restricted. In some implementations the accessed search related structured data may include all search related structured data pertaining to the URL. In some implementations, accessing the URL with the access key may cause an authenticated HTTP POST message to be sent (e.g., by a server hosting the URL or other server) to structured data association engine 310 that includes the user supplied search related structured data. Additional and/or alternative methods may be utilized to provide search related structured data.

In some implementations PageMap formatted search related structured data may be provided when a target URL is accessed with an access key. In some implementations search related structured data may additionally and/or alternatively be provided in other formats. For example, search related structured data may additionally or alternatively be provided via meta tags, Microformats, RDFa, and/or Microdata.

At step 215 the search related structured data is associated with a record of the URL in a search database. In some implementations step 215 and step 110 of FIG. 1 may share one or more common aspects. In some implementations the search related structured data may be associated with a record of the URL in content database 315 (FIG. 3). For example, structured data association engine 310 may store associated webpage and search related structured data on content database 315.

For example, one or more attributes of search related structured data may be associated with the URL. An access key may also optionally be associated with one or more of the attributes for that URL. In some implementations, the association of the access key may make the attributes access-restricted data in the content database 315. In order for the access-restricted data to be accessible to a requesting application, that requesting application must provide the access key. For example, the data may only be utilized by a search engine (e.g., search engine 305) when the search engine supplies the access key. In some implementations the access key associated with the search related structured data may be the same as the private URL access key. In some other implementations any access key associated with the search related structured data may be unique from the private URL access key.

In some implementations the search engine may be a site-specific custom search engine and the content database 315 may be accessible by the custom search engine. In some implementations the search engine may be a non-site-specific search engine. Any access-restricted data may include data that is not available through direct analysis of the webpage. For example, the access-restricted data may represent data concerning a webpage that is distinct from any data that may be obtained through crawling of that publicly accessible webpage. In some implementations the access key may be associated with one or more attributes, but stored in a separate filed in the content database 315 than the attributes. In some implementations the access key may be integrated into the private, access restricted search related structured data. Additional and/or alternative methods of otherwise restricting access to search related structured data may be utilized.

In some implementations one or more aspects of the user supplied search related structured data may be non-access restricted. In some of those implementations the aspects may be in a database that is publicly accessible and that enables viewing of the values associated with the attributes. In some other implementations the aspects may be private data not directly viewable to the public, but that may be utilized by a search engine (e.g., search engine 305) having access to content database 315, without requiring an access key to be provided. For example, in some implementations one or more search engines may enable identification and/or restriction of search results based in whole or in part on an attribute, without making that attribute directly publicly accessible.

In some implementations a user submission of search related structured data may be associated with the target URL in the content database 315 and available for utilization by a search engine within a predefined time of submitting the search related structured data. For example, in some implementations the target URL may be accessed utilizing the access key to obtain the search related structured data and such data may be associated with the URL in the content database 315 and available for utilization in less than six hours from submission. In some implementations a user submission of search related structured data may be associated with the URL in the content database 315 and available for utilization by a search engine during a previously unscheduled update sequence. In some implementations a search related structured data submission quota may be provided for each URL and/or user. In some implementations quotas may be applicable to a domain, a URL, a user, a set of domains, and/or a set of URLs. The quotas may optionally be individually configured per entity (e.g., some domains and/or URLs provided with a higher quota than others).

In some implementations at least some of the search related structured data supplements web crawl data obtained via crawling of the target URL without utilizing the access key. For example, in some implementations the user submitted search related structured data may include private, optionally access-restricted, data that is inaccessible via crawling of the URL without utilizing the access key. Such private search related structured data may be stored in content database 315 and represent data that is in addition to any structured data obtained through crawling of the URL while utilizing the access key. Also, for example, in some implementations user submitted search related structured data may include data that is accessible via crawling of the URL, but the URL has yet to be crawled since the data was present on the URL. Accordingly, such data may supplement other structured data that has been obtained through crawling of the URL. If the data relates to an attribute that has not previously been defined through crawling of the URL, then in some implementations the data may supplement and be in addition to data obtained via crawling of the URL. If the data relates to an attribute that has previously been defined through crawling of the URL, then in some implementations the data may supplement and optionally supplant data obtained via crawling of the URL.

In some implementations any user submitted search related structured data will be merged with any existing search related structured data obtained via crawling of the URL. In some implementations that implement access-restriction, a separate set of access-restricted search related structured data may be provided that includes user submitted search related structured data. In some implementations only user submitted search related structured data is included in such a separate set. In some implementations search related structured data obtained via crawling of the URL may also be included in such a separate set.

FIG. 3 illustrates a block diagram of an example environment in which search related structured data associated with a URL may be submitted by a user and associated with a record of the URL in a search database. The environment includes a communication network 301 that allows for communication between various components of the environment. The communication network 301 facilitates communication between the various components in the environment. In some implementations the communication network may include the Internet, one or more intranets, and/or one or more bus subsystems. The communication network 301 may optionally utilize one or more standard communications technologies, protocols, and/or inter-process communication techniques.

The structured data association engine 310 may receive user submitted search related structured data associated with a webpage and store such data in content database 315 or elsewhere utilizing techniques such as those described herein. In some implementations the structured data association engine 310 may perform one or more of the steps of the methods of FIG. 1 and/or FIG. 2. The structured data association engine 310 may be implemented in hardware, firmware, and/or software running on hardware. For example, the structured data association engine 310 may be implemented in one or more computer servers.

In some implementations the search related structured data that is stored by the structured data association engine 310 may be utilized by an information retrieval system such as search engine 305. In some implementations a user may interact with the search engine 305 through the client computing device 330. The client computing device 330 and the search engine 305 each include memory for storage of data and software applications, a processor for accessing data and executing applications, and components the facilitate communication over the communication network 301. The computing device 330 executes one or more applications, such as web browsers (e.g., web browser 332), that enable the user to formulate completed queries and submit queries to the search engine 305. The search engine 305 receives a query and executes the query against a search engine content database (e.g., implemented in content database 315) of available documents such as web pages, images, text documents, and/or multimedia. The search engine 305 identifies content which matches the submitted query and responds by generating search results that are transmitted to the computing device 330 in a form that can be presented to the user. For example, in response to a query from the computing device 330, the search engine 305 may transmit a plurality of search results to be displayed in the web browser 332 that is executing on the computing device 330.

The search engine 305 may utilize the user submitted search related structured data in processing a user submitted search query. For example, in some implementations the search related structured data may be utilized to identify search results, to restrict search results, to sort search results, to supply content to the display of the search results, and/or to format the display of the search results.

Many other configurations are possible having more or less components than the environment shown in FIG. 3. For example, in some environments the search engine 305 may be omitted. Also, for example, in some environments the structured data association engine 310 and the search engine 305 may be combined.

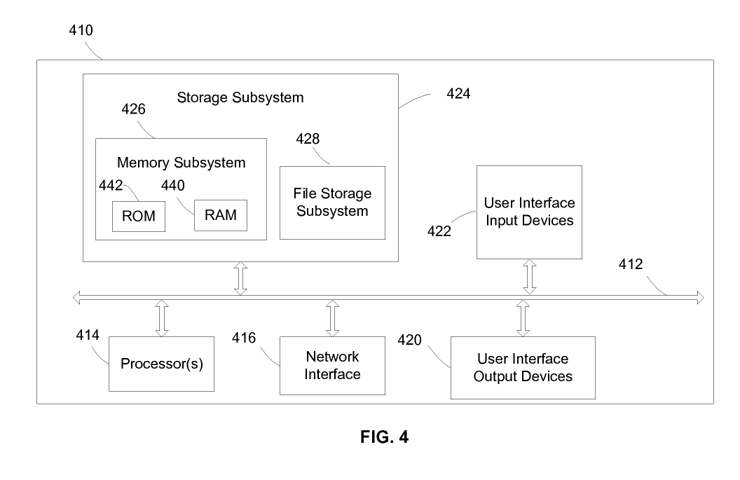

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 426 and a file storage subsystem 428, user interface input devices 422, user interface output devices 420, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to obtain user submitted search related structure data and store such data in a database associated with a URL according to one or more processes described herein.

These software modules are generally executed by processor 414 alone or in combination with other processors. Memory 426 used in the storage subsystem can include a number of memories including a main random access memory (RAM) 430 for storage of instructions and data during program execution and a read only memory (ROM) 432 in which fixed instructions are stored. A file storage subsystem 428 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 428 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

While several inventive implementations have been described and illustrated herein, a variety of other means and/or structures for performing the function and/or obtaining the results and/or one or more of the advantages described herein may be utilized, and each of such variations and/or modifications is deemed to be within the scope of the inventive implementations described herein. More generally, all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented method, comprising:
receiving a user generated request to associate user supplied search related structured data with a URL;
receiving the search related structured data for the URL from the user, the search related structured data being received without accessing a document directed to by the URL; and
associating, in response to the user generated request, the search related structured data with a URL record of the URL in a search database for use in response to a search request pertaining to the URL;
wherein at least some of the associated search related structured data supplements web crawl data associated with the URL record, the web crawl data obtained through crawling of the URL.

2. The method of claim 1, wherein the search related structured data includes at least one unique attribute type that is distinct from attribute types of the web crawl data obtained through crawling of the URL.

3. The method of claim 2, wherein the unique attribute type includes total number of reviews.

4. The method of claim 2, wherein the unique attribute type includes total number of downloads.

5. The method of claim 1, wherein at least some of the search related structured data supplants certain web crawl search related structured data of the web crawl data obtained through crawling of the URL.

6. The method of claim 1, wherein at least some of the search related structured data is inaccessible through the crawling of the URL.

7. The method of claim 1, further comprising associating at least some of the search related structured data with an access key and requiring a matching access key for access to the associated search related structured data.

8. The method of claim 1, wherein the step of associating the search related structured data with the URL record of the URL occurs within a predefined time period of receiving the user generated request.

9. The method of claim 1, further comprising identifying a user submitted indexing quota for the URL and wherein the step of associating the search related structured data with the URL record of the URL only occurs if the user submitted indexing quota has not been exceeded.

10. A computer implemented method, comprising:
receiving an update instruction from a user, the update instruction identifying at least one URL and providing access to associated user supplied search related structured data;
receiving user authentication data that identifies the user as authorized to make changes associated with the URL; and
modifying, based on the user authentication data identifying the user as authorized to make changes associated with the URL, an associated record in a database by including the user supplied search related structured data in the record, wherein the record is related to the URL and the database is a structured data database associated with a search engine;
wherein the update instruction received from the user initiates the modification of the associated record during a previously unscheduled update sequence.

11. The method of claim 10, wherein the search related structured data includes at least one unique attribute type that is distinct from attribute types of web crawl data obtained through scheduled crawling of the URL.

12. The method of claim 10, wherein at least some of the search related structured data supplements certain web crawl search related structured data of web crawl data obtained through crawling of the URL.

13. The method of claim 10, wherein at least some of the search related structured data is inaccessible through crawling of the URL.

14. The method of claim 10, wherein the step of modifying the associated record in the database occurs within a predefined time period of receiving the update instruction from the user.

15. The method of claim 10, further comprising identifying a user submitted indexing quota for the URL and wherein the step of modifying the associated record in the database only occurs if the user submitted indexing quota has not been exceeded.

16. The method of claim 10, wherein the URL is a publicly accessible URL appended with a private access key.

17. The method of claim 16, wherein at least some of the user supplied search related structured data is accessible via crawling of the URL and inaccessible via crawling of the publicly accessible URL.

18. The method of claim 10, wherein at least some of the user supplied search related structured data is associated with an access key in the database.

19. A system, comprising:
memory and one or more processors operable to execute instructions stored in the memory, wherein the instructions comprise instructions to:
receive a user generated request to associate user supplied search related structured data with a URL, the search related structured data being received without accessing a document directed to by the URL;
receive the search related structured data for the URL from the user; and
associate, in response to the user generated request, the search related structured data with a URL record of the URL in a search database for use in response to a search request pertaining to the URL;
wherein at least some of the associated search related structured data supplements web crawl data associated with the URL record, the web crawl data obtained through crawling of the URL.

20. A system, comprising:
memory and one or more processors operable to execute instructions stored in the memory, wherein the instructions comprise instructions to:
receive an update instruction from a user, the update instruction identifying at least one URL and providing access to associated user supplied search related structured data;
receive user authentication data that identifies the user as authorized to make changes associated with the URL; and
modify, based on the user authentication data identifying the user as authorized to make changes associated with the URL, an associated record in a database by including the user supplied search related structured data in the record, wherein the record is related to the URL and the database is a structured data database associated with a search engine;
wherein the update instruction received from the user initiates the modification of the associated record during a previously unscheduled update sequence.
